(19) United States
(12) Patent Application Publication
(10) Pub. No.: US 2021/0396163 A1
(43) Pub. Date: Dec. 23, 2021

(54) Scavenger Valve Method and Device

(71) Applicant: Compressor Engineering Corporation, Houston, TX (US)

(72) Inventors: Justin K. Russell, Needville, TX (US); Ricknold Gregory, Houston, TX (US); Ryan Miller, Manvel, TX (US); Christopher Rojas, Pearland, TX (US)

(73) Assignee: Compressor Engineering Corporation, Houston, TX (US)

(21) Appl. No.: 17/461,747

(22) Filed: Aug. 30, 2021

Related U.S. Application Data
(63) Continuation of application No. 16/463,722, filed on May 23, 2019, now abandoned.
(60) Provisional application No. 62/518,909, filed on Jun. 13, 2017.

(51) Int. Cl. F01L 1/38; F01L 3/22; F02B 75/02; F01L 9/16

(52) U.S. Cl. CPC F01L 1/38; F01L 3/22; F01L 2003/251; F01L 9/16; F02B 75/02

(57) ABSTRACT

A scavenger valve and method of directing gas in a two stroke engine are provided involving poppet elements in a scavenger valve with specific multiple, different flow paths from individual poppet heads.

### RELATED APPLICATION

This application is a U.S. continuation application of U.S. Nonprovisional patent application Ser. No. 16/463,722, filed May 23, 2019, which is a 371 of International Application No. PCT/US18/37291 filed Jun. 13, 2018 which claims priority to U.S. Provisional Application No. 62/518,909, filed Jun. 13, 2017.

### BACKGROUND OF THE INVENTION

Scavenger valves are intake valves in two-stroke engines and are known to those of skill in the art. As described at https://www.geoilandgas.com/sites/geog/files/ajax_integral_engine_comp_bro_-_8.5×11_final.pdf, and seen in FIG. 6, the engine comprises a cylinder 602 and piston 604 that reciprocates in the piston 602. As a fuel/air mixture explodes near the top of the stroke of the cycle of the piston in the cylinder, the exploding gas expands, pushing the piston down, turning a crank-shaft 606. As the piston passes scavenger valve 608 and exhaust port 610, the pressure differential causes the spent mixture to pass through the exhaust port while a new fuel/air mixture is passed into the cylinder 602. As the piston then moves up past the exhaust port 610, pressure builds in the cylinder 602 and ignition of the fuel/air mixture occurs near the top of the cylinder stroke, starting the cycle over again.

Traditionally, the scavenger valve has been a reed type of valve which was found to be inefficient. In more recent times, poppet-element valves have been used as scavenger valves with some success. An example is seen in U.S. Pat. No. 6,932,109, which is incorporated by reference herein for all purposes. However, the poppet-element valves have been expensive to make. Further, there has been a desire to improve efficiency in scavenger valves which, in turn, improves efficiencies in the engines in which the valve is used.

### SUMMARY OF EXAMPLES OF THE INVENTION

According to one example of the invention, a scavenger valve is provided comprising: a guard plate including: at least one line of poppet elements having substantially round poppet heads. IN one example, at least some of the poppets have four exposed sections; and, for each exposed section, at least some of the gas flowing over the exposed sections flows directly into separate exit port, located in guard plate, without flowing over any part of the guard plate. Each of the four exposed sections is exposed to a different exit port than the other exposed sections of any individual poppet head. The valve also includes a seat plate including a valve seat that is positioned and arranged to engage the poppet head. In at least one example embodiment, the seat plate further comprises a spacer portion integrally formed in said seat plate and determining the lift of the poppet element.

In some examples, at least some of the poppets have three exposed sections such that, for each exposed section, at least some of the gas flowing over the exposed section flows directly into an exit port without flowing over any part of the guard plate. Each of the three exposed sections is exposed to a different exit port than the other two exposed sections of any individual poppet head.

In some such examples, the total angle of exposure of each of a majority of the poppets is between about 180 degrees and about 225 degrees. As used in this document, “angle of exposure” refers to the angle measured from the center of a poppet head to its circumference at the points where the circumference is shaded from an exit port by the guard plate. For example, as seen in FIG. 5, intersection points 506 and 508 shows those point as an “exposure angle” defined by those points and the center of the poppet head, measured at the center of the poppet head.

In a further example, the total angle of exposure of some of the poppets is about 183 degrees. In the illustrated example, the exit ports are substantially circular in cross-section, with the exception of the exit ports at the perimeter of guard plate 114. In a further example, the diameter of at least one poppet head is greater than about one inch. In some more specific examples, the diameter is between about 1.325 inches and about 1.345 inches.

In some examples, some exit ports have four poppet head segments partially disposed in line with the single exhaust port, wherein at least some of the gas flowing over the poppet heads associated with segments flows directly into the exit port without flowing over any part of the guard plate.

In some examples, for any given circular exit port having four poppet elements exposed, the angle of exposure of each of four poppet elements is more than about 43 degrees.

A seat plate including a valve seat is positioned and arranged to engage the poppet heads. Also, in some examples, the guard plate further comprises a spacer portion integrally formed in said seat plate and determining the lift of the poppet elements. Poppet elements are biased against said seat plate and further against the seat area by springs that are located in said guard plate; however, other means of biasing poppets are known in the art that may be equally effective.

In some examples, the valve includes a maximum free lift area of about 43.8 square inches; in further examples, the valve included an effective flow area of between about 13.3 and about 58.0 square inches is obtained for between about 24 and about 90 poppet elements. In still further examples, the valve includes an effective force area of between about 23.9 and 89.5 square inches for between about 24 and 90 poppet elements.

Is some examples of the invention, a method is provided for directing intake gas in a multiple-poppet-element scavenger valve in a two stroke engine, wherein the valve comprises: a seat plate disposed opposite a guard plate, with at least one line of poppet elements having substantially circular poppet heads, the poppet elements being mounted in the guard plate in holes and biased, for example, by springs. In some examples, the guard plate also includes at least one exit port. In such an example, the method comprises: receiving a poppet opening pressure from the intake gas; and directing over ½ of gas particles flowing across at least one poppet head directly into the engine. In at least one example, said directing comprises directing particles that are flowing across an individual poppet head through at least three separate flow paths defined by exit ports and into directly into an engine.

In a further example, the method the directing comprises directing gas particles the poppet head through at least four separate flow paths defined by exit ports directly into the engine.

In still a further example of the invention, a device is provided for directing intake gas in a multiple-poppet-element scavenger valve in a two-stroke engine. In at least one example, the device includes: a means for receiving a poppet opening pressure from the intake gas; and means for directing over ½ of gas particles flowing across at least one poppet head directly into the engine. In one example, the means for receiving comprises a seat plate and a set of poppet elements biased against said seat plate to open when the opening pressure exceeds a bias force of the poppets by springs against the seat area. In one example, said means for directing comprises a guard plate, with at least one line of the set of poppet elements, having substantially circular poppet heads, mounted in the guard plate, the guard plate also having at least three exit ports each defining a distinct flow path into the engine, wherein over ½ of the circumference of at least some of the set of poppet elements is disposed directly over the three distinct exit paths.

It has been found that scavenger valves made according to the invention provide lower manufacturing cost, repair, and more efficiency of both the valve and the engine. It is an object of aspects of the invention to provide a valve that is less expensive to manufacture and more efficient. It if a further object of an aspect of the invention to provide a two-stroke engine that is less expensive to make and more efficient.

### BRIEF DESCRIPTION OF THE DRAWINGS

FIG. 1 is an exploded view of an example of the invention.

FIG. 2 is a top view of an example of the invention.

FIG. 2A is a sectional view taken through line A of FIG. 2.

FIG. 3 is a top view of a guard plate used according to an example of the invention.

FIG. 3A is a sectional view taken through line A of FIG. 3.

FIG. 4 is a bottom view of a seat plate used according to an example embodiment of the invention.

FIG. 4A is a sectional view taken through line A of FIG. 4.

FIG. 5 is a bottom view of a guard plate used according to an example of the invention.

FIG. 6 is a sectional view of a motor used according to an example of the invention.

### DETAILED DESCRIPTION OF EXAMPLES OF THE INVENTION

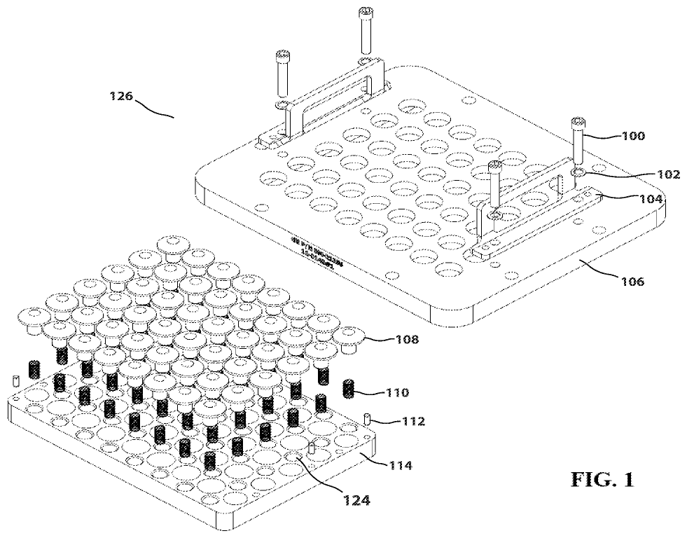

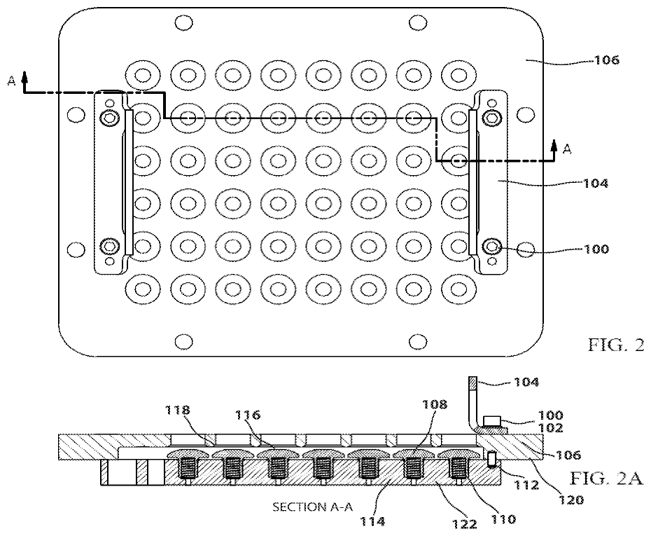

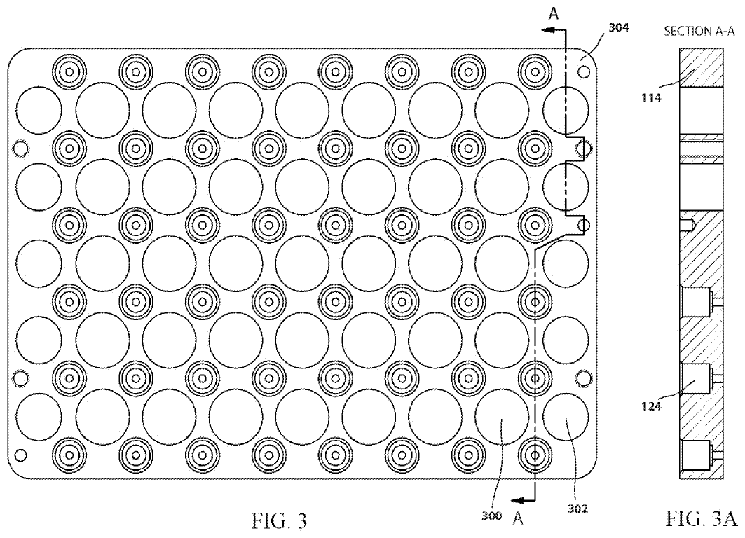

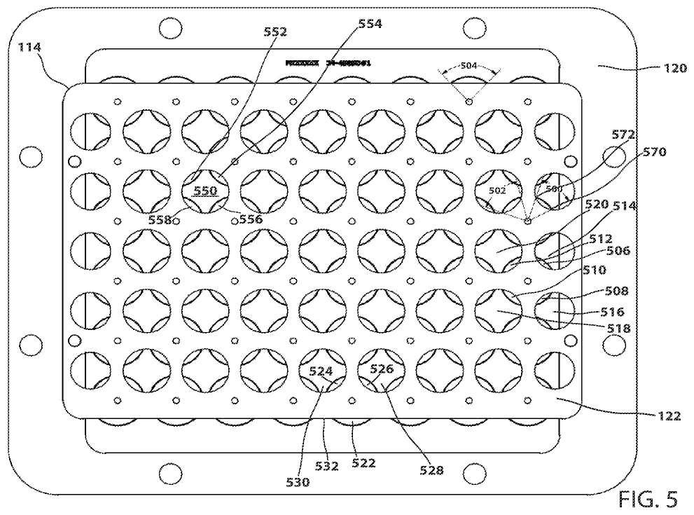

Referring to FIG. 1, a three-dimensional exploded view of an example of the invention is seen that includes a scavenger valve 126 comprising: a guard plate 114 including: at least one line of poppet elements 108 which are biased by springs 110 and have substantially round poppet heads (116 of FIG. 2A), seat plate 106 including handle 104, which is secured with seat plate 106 and guard plate 114 with bolts 100 and washers 102. Referring now to FIG. 5, the rear surface 122 of guard plate 114 is seen, showing that at least some of the poppets have four exposed sections (506, 508, 510, and 512). Further, for each exposed section at least some of the gas flowing over the exposed sections flows directly into separate exit port (514, 516, 518, and 520, respectively), each of which is located in guard plate 114. Those gas flows occur without flowing over any part (for example, top surface 304 of guard plate 114 in FIG. 3) of the guard plate 114.

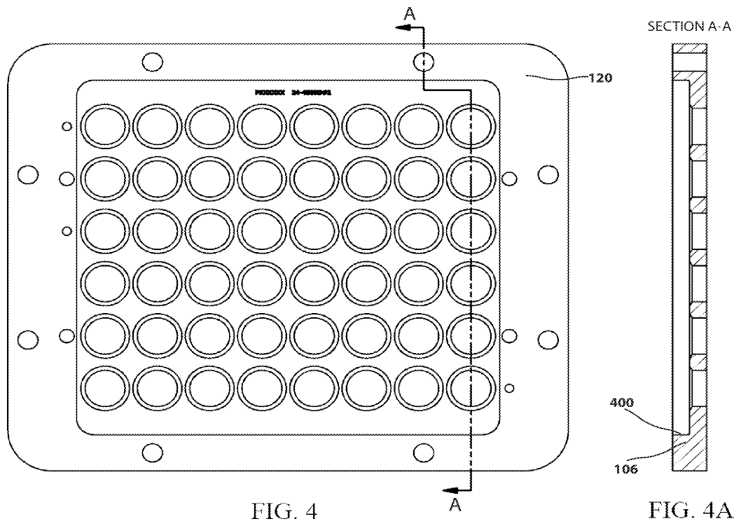

Referring again to FIG. 5 each of the four exposed sections (506, 508, 510, and 512) is exposed to a different exit port (514, 516, 518, and 520) than the other exposed sections of any individual poppet head 108. Referring again to FIGS. 2 and FIG. 2A and FIGS. 4 and 4A, valve 126 also includes a seat plate 106 including a valve seat 118 positioned and arranged to engage the poppet head 116. In at least one example embodiment, the seat plate 106 further comprises a spacer portion 400 integrally formed in the seat plate 106 and determining the lift of the poppet elements 108.

Referring again to FIG. 5, in some examples, at least some of the poppets have three exposed sections (522, 524, 526) such that, for each exposed section, at least some of the gas flowing over the exposed section flows directly into an exit port (528, 530, 532) without flowing over any part of the guard plate (e.g., surface 304 of guard plate 114 of FIG. 3). Referring again to FIG. 5, each of the three exposed sections (522, 524, and 526) is exposed to a different exit port (528, 530, and 532) than the other two exposed sections of any individual poppet head 108.

In some such examples, the total angle of exposure of each of a majority of the poppets 108 is between about 180 degrees and about 225 degrees.

As used in this document, “angle of exposure” refers to the angle measured from the center of a poppet head to its circumference at the points where the circumference is shaded from an exit port by the guard plate. For example, as seen in FIG. 5, an exposure angle is defined by intersection points 570 and 572 and the center of the poppet head. The exposure angle is the angle at the center of the poppet head.

In a further example, the total angle of exposure of some of the poppets 108 is about 183 degrees. As used in this document, “total angle of exposure” means the total, in degrees of the angle of exposure of each exposed segment. In the illustrated example, the exit port is substantially circular in cross-section, with the exception of the exit ports at the perimeter of guard plate 114 (e.g., port 532 of FIG. 5). In a further example, the diameter of at least one poppet head 116 is greater than about one inch. In some more specific examples, the diameter is between about 1.325 inches and about 1.345 inches.

As seen in FIG. 5, in some examples, some exit ports (e.g., port 500) have four poppet head segments (552, 554, 556, and 558) partially disposed in line with the single exhaust port (550), wherein at least some of the gas flowing over the poppet heads associated with segments (552, 554, 556, and 558) flows directly into the exit port (550) without flowing over any part (304 of FIG. 3) of the guard plate 114.

Again as seen in FIG. 5, for any given circular exit port having four poppet elements exposed, the angle of exposure (e.g., angles 500 and 502) of each of four poppet elements is more than about 43 degrees.

Referring again to FIGS. 2 and 2A, a seat plate 106 including a valve seat 118 is positioned and arranged to engage the poppet heads 116. Also, the seat plate 106 further comprises a spacer portion 400 integrally formed in said seat plate 106 and determining the lift of the poppet elements 108. Poppet elements 108 are biased against said seat plate 106 and further against the seat area 118 by springs 110 located in said guard plate 114; however, other means of biasing poppets are known in the art that may be equally effective.

In some examples, the valve includes a maximum free lift area of about 43.8 square inches. In further examples, an effective flow area of between about 13.3 and about 58.0 square inches is obtained for between about 24 and about 90 poppet elements. In still further examples, an effective force area of between about 23.9 and 89.5 square inches is obtained for between about 24 and 90 poppet elements.

Is some examples of the invention, a method is provided for directing intake gas in a multiple-poppet-element scavenger valve in a two stroke engine, wherein the valve comprises: a seat plate 106 disposed opposite a guard plate 114, with at least one line of poppet elements 108 having substantially circular poppet heads 116, the poppet elements 108 being mounted in the guard plate 114 in holes 124 (FIGS. 3 and 3A) and biased, for example, by springs 110 (FIG. 1).

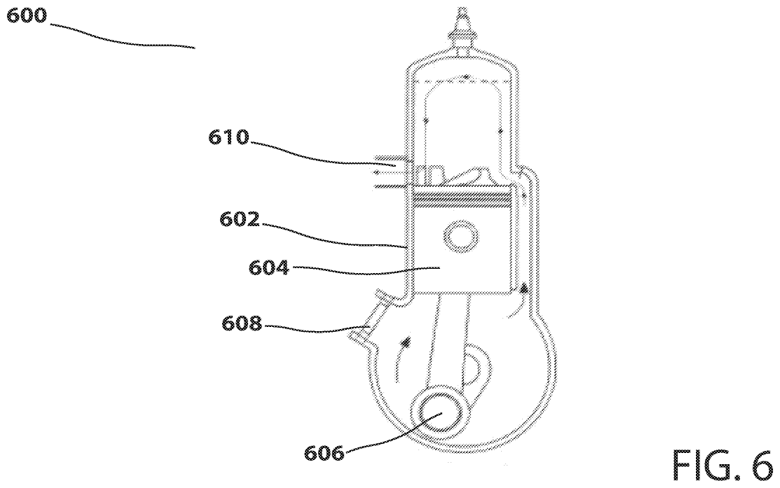

In some examples, the guard plate 114 also includes at least one exit port 300. In such an example, the method comprises: receiving a poppet opening pressure from the intake gas; and directing over ½ of gas particles flowing across at least one poppet head directly into the engine. In at least one example, said directing comprises directing particles that are flowing across an individual poppet head 116 through at least three separate flow paths defined by exit ports 300 and 302 into directly into the engine 600 of FIG. 6.

In a further example, the method of directing comprises directing gas particles the poppet head 116 through at least four separate flow paths defined by exit ports 300 directly into the engine 600.

In still a further example of the invention, a device is provided for directing intake gas in a multiple-poppet-element scavenger valve in a two stroke engine. In at least one example, the device includes: a means for receiving a poppet opening pressure from the intake gas; and means for directing over ½ of gas particles flowing across at least one poppet head directly into the engine. In one example, the means for receiving comprises a seat plate 106 and a set of poppet elements biased against said seat plate 106 to open when the opening pressure exceeds a bias force of the poppets 108 by springs 110 against the seat area 118. In one example, said means for directing comprises a guard plate 114, with at least one line of the set of poppet elements 108, having substantially circular poppet heads 116, mounted in the guard plate 114, the guard plate 114 also having at least three exit ports 300 each defining a distinct flow path into the engine, wherein over ½ of the circumference of at least some of the set of poppet elements 108 is disposed directly over the three distinct exit paths.

The above description is by way of example only, and variants from the above will occur to those of ordinary skill that are within the spirit of the invention; nothing in this section or previous sections should be interpreted to limit the scope of the invention beyond that defined by the claims below, unless a term is specifically defined.

What is claimed is:

1. A method of directing intake gas in a multiple-poppet-element two-stroke_scavanger valve, the valve comprising a seat plate disposed opposite a guard plate, with at least one line of poppet elements having poppet heads, the poppet elements being mounted in the guard plate, the guard plate also having at least one exit port, the method comprising:
receiving in the two-stroke scavenger valve a poppet opening pressure from the intake gas; and
directing over ½ of gas particles flowing across at least one poppet head directly into the engine.

2. The method as in claim 1, wherein said directing comprises directing particles across the at least one poppet head through at least three separate flow paths into directly into the engine.

3. The method as in claim 2, wherein said directing comprises directing particles across the at least one other poppet head through at least four separate flow paths into directly into the engine.

4. A device for directing intake gas in a multiple-poppet-element two-stroke engine scavenger valve, the device comprising:
means for receiving in the two-stroke engine scavenger valve a poppet opening pressure from the intake gas; and
means for directing over ½ of gas particles flowing across at least one poppet head directly into the engine.

5. The device as in claim 4, wherein said means for receiving comprises a seat plate and a set of poppet elements biased against said seat plate to open when the opening pressure exceeds the bias of the poppets against the seat plate.

6. The device as in claim 5, wherein said means for directing comprises a guard plate, with at least one line of the set of poppet elements, having substantially circular poppet heads, mounted in the guard plate, the guard plate also having at least three exit ports each defining a distinct flow path into the engine, wherein over ½ of the circumference of at least some of the set of poppet elements is disposed directly over the three distinct exit paths.

7. A scavenger valve comprising:
a scavenger valve_guard plate including:
at least one line of poppet elements having substantially round poppet heads,
at least one exit port having four poppet elements partially disposed in line with the exit port, wherein at least some of the gas flowing over the poppet head flows directly into the exit port without flowing over any part of the guard plate;
wherein an angle of exposure of each of four poppet elements is more than 43 degrees;
a scavenger valve_seat plate including a valve seat positioned and arranged to engage the poppet head.

8. The valve as in claim 7, wherein the guard plate further comprises a spacer portion integrally formed in said guard plate and determining the lift of the poppet elements.

9. The valve as in claim 7, wherein the poppet elements are biased against said seat plate.

10. The valve as in claim 9, wherein the poppet elements are biased by springs located in said guard plate.

11. A scavenger valve comprising:
a scavenger valve guard plate including:
at least one line of poppet elements having substantially round poppet heads;
wherein at least some of the poppets have four exposed sections such that, for each exposed section:
at least some of the gas flowing over the exposed section flows directly into an exit port located in said guard plate without flowing over any part of the guard plate and each of the four exposed sections is exposed to a different exit port than the other three exposed sections of any individual poppet head;
a scavenger valve seat plate including a valve seat positioned and arranged to engage the poppet head.

12. The valve as in claim 11, wherein the guard plate further comprises a spacer portion integrally formed in said seat plate and determining the lift of the poppet elements.

13. The valve as in claim 11, wherein at least some of the poppet have three exposed sections such that, for each exposed section, at least some of the gas flowing over the exposed section flows directly into an exit port without flowing over any part of the guard plate and each of the three exposed sections is exposed to a different exit port than the other two exposed sections of any individual poppet head.

14. The valve as in claim 13, wherein the total angle of exposure of each of a majority of the poppets is between 180 degrees and 225 degrees.

15. The valve as in claim 14, wherein the total angle of exposure of some of the poppets is 183 degrees.

16. The valve as in claim 14, wherein the total angle of exposure of some of the poppets is 225 degrees.

17. The valve as in claim 16, wherein the total angle of exposure of some of the poppets is 183 degrees.

18. The valve as in claim 11, wherein said exit port is round in cross-section.

19. The valve as in claim 11, wherein the diameter of at least one poppet is greater than one inch.

20. The valve as in claim 19 wherein the diameter of a plurality of the poppets is 1.325 inches.

21. The valve as in claim 19 wherein the diameter of a plurality of the poppets is 1.345 inches.
